(19) United States
(12) Patent Application Publication
(10) Pub. No.: US 2008/0025539 A1
(43) Pub. Date: Jan. 31, 2008

(54) Otological device having a holding device for a tragus

(76) Inventors: John Bailey, Crawley (GB); Uwe Rass, Nuremberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/825,069

(22) Filed: Jul. 3, 2007

(30) Foreign Application Priority Data
Jul. 3, 2006 (DE) 10 2006 030 600.7

(51) Int. Cl. H04R 25/00

(52) U.S. Cl. 381/322

(57) ABSTRACT

The invention relates to an otological device, for example, a hearing aid or a tinnitus masker, to be worn in the area of a listener's ear. The otological device is designed to be worn at least partially attached to the tragus of a listener's ear. The otological device comprises an holding device that forms a gripping element for partially encloseing a tragus of the ear and locking onto the tragus with a positive or non positive fit. The otological device is designed to fill only partially an auditory canal of the ear or additionally a concha of the ear so that the auditory. canal can be at least partially seen.

### CROSS REFERENCE TO RELATED APPLICATIONS

This application claims priority of German application No. 2006 030 600.7 filed Jul. 3, 2006, which is incorporated by reference herein in its entirety.

### FIELD OF THE INVENTION

The invention relates to an otological device, for example, a hearing aid or a tinnitus masker, to be worn in the area of a listener's ear.

### BACKGROUND OF THE INVENTION

DE 332 810 0 A1 discloses a miniature sound transmission device, which comprises a holding device for wearing on a pinna. The holding device for wearing on a pinna can be tucked into an auditory canal.

DE 297 184 83 U1 discloses a holding device for the attachment of otological devices. The holding device is designed to be connected to an otological device. The holding device has interconnected support elements which are each provided for securing the holding device with a positive fit on the inside of a concha.

### SUMMARY OF THE INVENTION

With in-the-ear hearing aids known from the prior art, there is the problem that the hearing aid is difficult for a user to access or can be difficult to remove. A further problem is that an in-the-ear hearing aid completely closes the auditory canal, something that is associated with a corresponding sensation for a wearer when worn and with a corresponding optical impression for other people.

With behind-the-ear hearing aids, there is the problem that it is only with difficulty or with very considerable discomfort that such hearing aids can be worn in conjunction with a visual aid.

The problem is solved by an otological device, for example, a hearing aid or a tinnitus masker, to be worn in the area of a listener's ear, the otological device being designed to be worn at least partially attached to the tragus of a listener's ear.

Such an otological device can advantageously be designed so that it does not completely close an auditory canal. A further advantage is that such an otological device can be worn on the tragus of a listener's ear and thus does not have a clip to attach it behind a listener's ear so that a visual aid and a hearing aid can be worn together.

In a preferred embodiment, the otological device has a holding device, which is designed to encompass at least partially a tragus of a listener's ear. Preferably, the otological device can be attached to a tragus, in particular with a positive or non-positive fit. As a result, the otological device can be worn on a tragus in such a way that it cannot be dislodged from the tragus by accelerations caused in particular by the movements of a wearer.

For example, the holding device can at least partially enclose a tragus—in particular between two gripping elements formed by the holding device or by a clip that is thus formed and thus lock onto the tragus.

In an advantageous embodiment, the holding device is at least partially formed by a retaining clip that is functionally connected to the otological device, the retaining clip being designed to at least partially enclose a tragus of a listener's ear.

Advantageously, the retaining clip can be connected to the otological device by means of a spring element. The spring element can advantageously have a lower modulus of elasticity than the retaining clip itself. As a result thereof, a contact pressure of the retaining clip on a tragus can advantageously be predetermined by means of a modulus of elasticity of the spring element.

In an advantageous embodiment, the retaining clip is integrally connected to at least one housing component of the otological device.

In this way, during a production process a retaining clip can be molded onto an otological device in a simple manner, and for example, manufactured in an injection molding step of an injection molding process.

In a preferred embodiment of the holding device, said holding device has holding tongs which are partially formed by a retaining clip of the aforementioned type and partially by a housing component of the otological device. In this way, holding tongs can advantageously be formed, one holding tong claw being formed by the retaining clip and one holding tong claw provided to apply counter-pressure being formed by at least one part of the hearing device housing.

In an advantageous variant of the otological device, the retaining clip is connected to the otological device by means of a joint, in particular a pivotable joint or a ball joint.

For example, in the case of an embodiment having a pivotable joint, the retaining clip can be functionally connected to a push spring which is arranged and designed to push the retaining clip onto a tragus, preferably onto the side of the tragus that faces the auditory canal. A hearing device housing or a part of a hearing device housing, for example, can form a counter-bearing for the push pressure that is thus exerted.

In the case of a ball joint, the otological device can, for example, have a locking device, in particular having a bayonet pin, which is designed to provide spring-actuated locking of a ball of a ball joint.

In addition to the ball joint, in a variant of an otological device having a ball joint, a retaining clip can be connected to a housing of the otological device by means of the ball joint and in particular also have a push spring to push the retaining clip against a tragus.

In an advantageous embodiment, the holding device is at least partially spring-mounted such that a sufficient push pressure on the tragus can be generated to secure the otological device on a tragus.

In this embodiment, the retaining clip itself can, for example, have a modulus of elasticity and/or, in an area of the retaining clip in which the retaining clip is molded onto a hearing device housing, a geometrical shape which gives the retaining clip an increased mobility in this area, in particular the ability to pivot.

In a preferred embodiment, in an arrangement provided for wearing on a listener's ear, the otological device is at least partially arranged outside the concha without gripping behind the pinna. In this way an otological device can be perceived by another person as being turned outwards.

In an advantageous embodiment of the otological device, the otological device has a mechanical interface for connection to a decorative plate, the decorative plate being designed to at least partially conceal the otological device, such that the otological device cannot easily be seen or cannot be seen at all by a third party when the otological device is worn on a listener's ear. In this embodiment the impression given to another person is rather that of a piece of jewelry.

In a preferred, advantageous embodiment of the otological device, in an arrangement to be worn on a listener's ear, the otological device is designed to fill only partially the auditory canal and/or the concha. As a result, advantageously, it is at least partially possible for other people to see into an auditory canal of a wearer of the otological device and in this way a natural appearance can be conveyed. In this embodiment, the otological device is perceived, for example, as a piece of jewelry or as an unobtrusive auxiliary device.

An otological device can advantageously have a mechanical interface for connection to a covering element. Such a covering element can, for example, convey the impression of a piece of jewelry or can advantageously form a piece of jewelry itself.

Advantageously, such an interface can be formed on one side of the otological device by an indentation or an opening or a recess in a hearing device housing, which is designed for the insertion of or connection to a corresponding counterpart in a covering device.

A covering device for an otological device of the aforementioned type can advantageously comprise a tappet or a peg or a pin which is designed for insertion into a corresponding recess in an otological device. Naturally the otological device or a housing of the otological device can have a tappet, a peg or a pin or suchlike which is, in each case, designed to engage with a corresponding recess of a covering device with a non-positive and/or positive fit.

In this embodiment, a covering device can advantageously have a corresponding recess, indentation or an opening, into which a tappet or a peg or a pin of an otological device can engage.

An otological device which is designed as a hearing aid can have a sound receiver and a sound generator.

The sound receiver is designed to receive sound waves and to generate a microphone signal representing the sound waves received.

The sound generator is designed to generate a sound as a function of a power signal received at the input end.

The hearing aid preferably has a transmission unit, which is connected at the input end to the sound receiver and at the output end to the sound transmitter and in which the transmission unit is designed to generate a power signal as a function of a microphone signal received at the input end, which power signal at least partially represents the microphone signal.

Advantageous materials for a hearing aid housing are biocompatible and can in each case comprise polypropylene, polyethylene, polyester, polyamide, polystyrene or polycarbonate or a combination thereof.

An advantageous embodiment of the otological device can comprise (in particular in addition to a holding device for locking onto a tragus) a support device which is designed to support the hearing aid additionally on at least one edge section of the concha and/or on a wall area of the concha with a positive and/or non-positive fit.

Such a support device can advantageously be designed as a ring support which is formed by an open ring having a first and a second open end.

The first open end of the ring support is preferably connected to the holding device, in particular to a retaining clip, in particular in a separable-manner. The second open end of the ring support is preferably connected to a section of the housing of the otological device, in particular in a separable manner.

The ring support is preferably designed to be elastic. For example, the ring support can be formed using a thermoplastic.

Further advantageous design variants of an otological device result from the features set out in the dependent claims or from a combination of the features set out in the dependent claims.

### BRIEF DESCRIPTION OF THE DRAWINGS

The invention is now described below with reference to the figures and further exemplary embodiments of an otological device.

FIG. 1 shows a schematic representation of an embodiment of an otological device designed as a hearing aid, which device is designed for wearing on a tragus;

FIG. 2 shows a schematic representation of an embodiment of an otological device, which device is designed for wearing on a tragus and essentially leaves an auditory canal open;

FIG. 3 shows a schematic representation of a view of the otological device shown in FIG. 2;

FIG. 4 shows a schematic representation of an embodiment of an otological device, which device is designed for wearing on a tragus and which comprises a decorative element;

FIGS. 5 and 6 each show embodiments of an otological device;

FIGS. 7 to 10 each show an otological device which comprises a support element;

FIG. 11 shows a view for a use on a listener's ear of the hearing aid shown in FIG. 6.

### DETAILED DESCRIPTION OF THE INVENTION

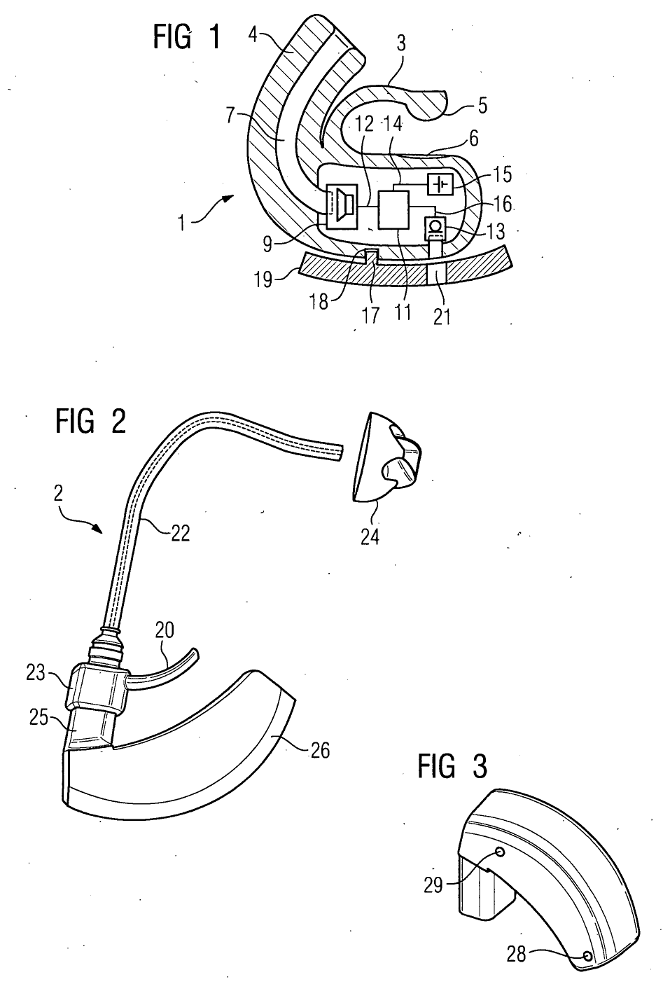

FIG. 1 shows a schematic representation of a sectional view of an otological device which is designed as a hearing aid 1.

The hearing aid 1 comprises a holding device 3 designed as a retaining clip having a pressure element 5.

The hearing aid 1. comprises a hearing aid housing having a housing area 6, wherein the housing area 6 and the pressure element 5 face each other and are distanced from each other such that the pressure element 5 and the housing area 6 can enclose a tragus between them.

The holding device 3 is molded onto a housing of the hearing aid.

The hearing aid 1 has a curved section 4, which is designed for at least partial insertion into an auditory canal. The curved section 4 encompasses a sound canal 7. The sound canal 7 is functionally connected to a sound generator 9.

The hearing aid 1 also has a transmission unit 11, which is connected to the sound generator 9 by way of a connecting cable 12. The transmission unit 11 is connected at the input end via a connecting cable 16 to a microphone 13. The microphone is designed to receive sound waves and to generate a microphone signal that represents the sound waves received.

The transmission unit 11 can be designed to generate a power signal as a function of a microphone signal received at the input end via the connecting cable 16 according to a predetermined allocation specification and to emit this power signal via the connecting cable 12 to the sound generator 9.

The sound generator 9 can generate an air-borne sound corresponding to the power signal and direct said sound via the sound canal 7 into an auditory canal. The transmission unit 11 is connected via a connecting cable 14 to terminals for a battery 15.

The hearing aid 1 has a recess 18, on an area of the hearing aid housing that is directed outwards when worn. The recess 18 is designed so that it receives and secures a tappet, in particular a tappet in a covering element, with a positive and/or non-positive fit.

The figure also shows a covering element 19 for a hearing aid 1, comprising a tappet 17 molded onto the covering element 19. The tappet 17 is designed for non-positive and/or positive insertion into a recess 18 of a hearing aid.

The covering element can comprise an opening 21 for a microphone aperture of the hearing aid 1.

The covering element 19 can, for example, be a decorative covering element which outwardly can be perceived as a piece of jewelry.

FIG. 2 shows an exemplary embodiment of a hearing aid 2. The hearing aid 2 has a hearing aid housing 26 which can be worn so that it is outwardly visible.

The housing 26 of the hearing aid 2 also comprises a support 25, which also encompasses a sound canal, the sound canal being functionally connected to a sound generator of the hearing aid 2.

The support 25 is designed such that a detachable part 23 can be attached to the support in such a way that the detachable part 23 at least partially encompasses the support 25. The detachable part 23 has on the inside a sound canal which, after attachment to the support 25, is functionally connected to the sound canal of the support 25.

The detachable part 23 is designed such that, after attachment to the support 25, a non-positive fit is provided to prevent detachment from the support 25.

The detachable part 23 comprises a retaining clip 20, said retaining clip 20 being molded onto the detachable part 23.

The retaining clip 20 is molded and arranged such that, in the attached state of the detachable part 23 onto the support 25, the retaining clip 20, in conjunction with an area of the hearing aid housing 26, forms claws which can enclose a tragus. The retaining clip 20 is, for example, curved in such a way that a convex side of the retaining clip 20 formed by the curvature in the attached state of the detachable part 23 faces towards the area of the hearing aid housing 26 that is provided to enclose a tragus.

A sound tube 22 is molded onto the detachable part 23, which tube encompasses a lumen to conduct a sound. The lumen is connected to the hollow area of the detachable part 23. The figure also shows an end piece 24 that is at least partially half-concave in shape and which can be attached onto an end of the sound tube 22 that it turned away from the hearing aid. The end piece 24 can comprise a silicon rubber, for example, which can be manufactured to correspond to an impression of a wearer's ear.

The end piece has an opening which, after attachment to the sound tube 22, is connected to the lumen of the sound tube 22.

FIG. 3 shows a view onto the otological device 2 shown in FIG. 2.

The otological device 2, designed as a hearing aid, has two microphones which are designed for directed reception of sound and which together can form a directional microphone.

The figure shows a microphone aperture 28 and a microphone aperture 29, a first microphone being able to receive an air-borne sound through the microphone aperture 28 and a second microphone being able to receive an air-borne sound through the microphone aperture 29.

FIG. 4 shows a schematic representation of an exemplary embodiment of a hearing aid 36 which can be worn on a tragus.

The hearing aid 36 is designed as a piece of jewelry and can be perceived as such towards the outside.

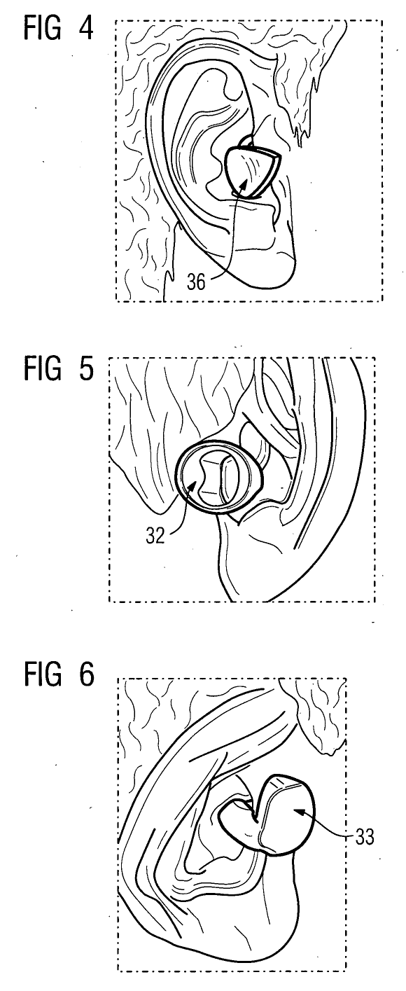

FIG. 5 and FIG. 6 respectively show schematic representations of otological devices 32 and 33, each of which can be attached to a tragus of a listener's ear and each of which are designed as a piece of jewelry or can be perceived as such.

The otological device 32 is partially hollow, designed to be a hollow cylinder, for example, and comprises a cavity edge that can enclose a tragus. In this embodiment the cavity can accommodate a tragus.

The otological device 33 comprises a housing area which can enclose a tragus from the outside. The housing area can be designed to be rounded off, for example.

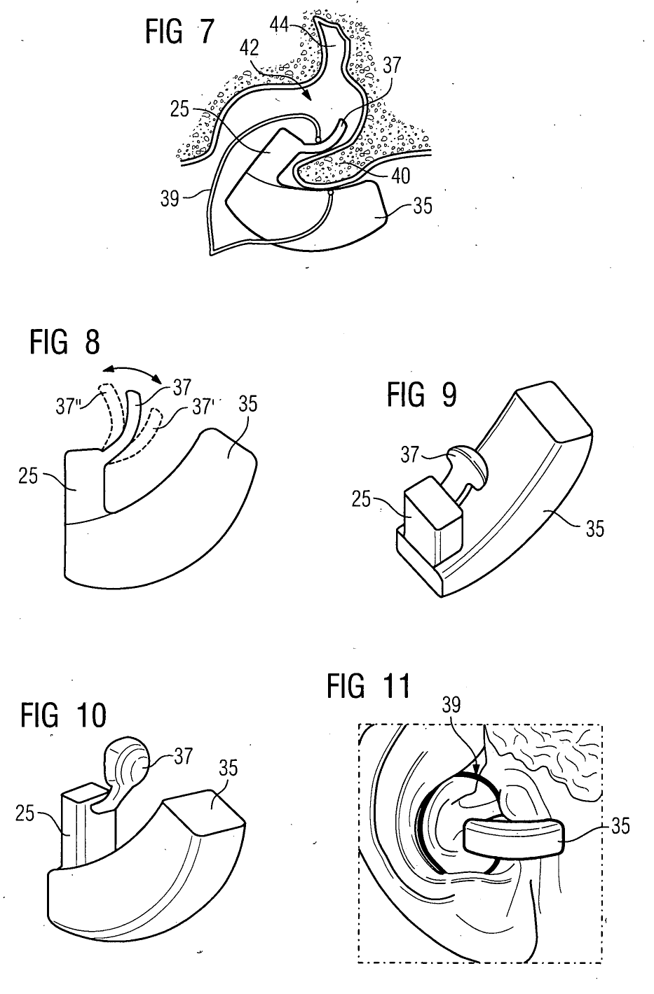

FIG. 7 shows a schematic representation of a variant of the hearing aid shown in FIG. 2 and FIG. 3. The hearing aid comprises a housing 35 and a support 25 that projects transversely from the housing.

A holding device 37, which device is designed to be elastic and pivotably mounted, is molded onto the support 25. An annular retaining clip 39 of the hearing aid 35 is designed to press the elastic holding device 37 against a tragus 40. The annular retaining clip 40 is connected to the hearing aid housing of the hearing aid 35.

FIGS. 8, 9 and 10 respectively show different views of the hearing aid shown in FIG. 7.

In FIG. 8 the pivotably mounted holding device 37 is in a pivoted position 37′ and in a pivoted position 7″.

FIG. 11 shows a view indicating the use of the hearing aid shown in FIG. 6 on a listener's ear. In the area of an edge of the concha, the retaining clip 39 rests against a wall of the concha. The retaining clip 39 thus effectively supports the hearing aid against a wall section of the concha since the retaining clip is functionally connected to the hearing aid.

1.-12. (canceled)

13. An otological device to be worn in an area of an ear of a user, comprising:
an holding device that at least partially encloses a tragus of the ear and locks onto the tragus,
wherein the otological device is configured to be worn at least partially to the tragus and partially fill an auditory canal of the ear so that the auditory canal can be at least partially seen.

14. The otological device as claimed in claim 13, wherein the holding device comprises a retaining clip that is functionally connected to the otological device.

15. The otological device as claimed in claim 14, wherein the retaining clip is connected to the otological device by a spring element.

16. The otological device as claimed in claim 14, wherein the retaining clip is integrally connected to a housing component of the otological device.

17. The otological device as claimed in claim 14, wherein the holding device comprises a holding tong comprising the retaining clip and a housing component of the otological device.

18. The otological device as claimed in claim 14, wherein the retaining clip is connected to the otological device by a joint.

19. The otological device as claimed in claim 18, wherein the joint is a pivotable joint or a ball joint.

20. The otological device as claimed in claim 13, wherein the holding device is spring-mounted for generating a sufficient push pressure to lock the otological device onto the tragus.

21. The otological device as claimed in claim 13, wherein the otological device is arranged outside a concha of the ear without gripping behind a pinna of the ear.

22. The otological device as claimed in claim 13, wherein the otological device partially fills a concha of the ear.

23. The otological device as claimed in claim 13, further comprising a support device for supporting the otological device on an edge section of a concha or a wall area of the concha of the ear.

24. The otological device as claimed in claim 23,. wherein the support device comprises an open ring having a first open end and a second open end.

25. The otological device as claimed in claim 24, wherein the first open end is connected to the holding device and the second open end is connected to a housing section of the otological device.

26. The otological device as claimed in claim 13, wherein the otological device comprises a mechanical interface for connecting to a decorative plate that conceals the otological device.

27. The otological device as claimed in claim 13, wherein the otological device comprises a mechanical interface for connecting to a covering element.

28. The otological device as claimed in claim 13, wherein the otological device is attached to the tragus with a positive or a non-positive fit.

29. The otological device as claimed in claim 13, wherein the otological device is a hearing aid or a tinnitus masker.

30. A method for manufacturing an otological device to be worn at least partially to a tragus of an ear of a user, comprising:
providing an holding device for at least partially enclosing the tragus and locking onto the tragus,
wherein the otological device partially fills an auditory canal of the ear so that the auditory canal can be at least partially seen.

31. The method as claimed in claim 30, wherein the otological device partially fills a concha of the ear.

32. The method as claimed in claim 30, wherein the otological device is a hearing aid or a tinnitus masker.
